(19) United States
(12) Patent Application Publication
(10) Pub. No.: US 2015/0086708 A1
(43) Pub. Date: Mar. 26, 2015

(54) METHOD OF PROCESSING A SUBSTRATE

(71) Applicants: Interface Optoelectronics (Shenzhen) Co., Ltd., Shenzhen City (CN); GENERAL INTERFACE SOLUTION LIMITED, MIAOLI COUNTY (TW)

(72) Inventors: Hung-Chieh Lu, New Taipei City (TW); Yen-Heng Huang, Taoyuan County (TW); Chung-Kai Chen, Taichung City (TW); Shih-Chieh Huang, Taichung City (TW); Li-Ting Cheng, Tainan City (TW); Chun-Lin Tseng, Hsinchu City (TW); Ho-Chieh Tseng, Taichung City (TW); Chiou-Chi Chen, Hsinchu City (TW); Chang-Kuei Huang, Hsinchu City (TW); Wei-Chung Chuang, Kaohsiung City (TW)

(21) Appl. No.: 14/555,672

(22) Filed: Nov. 27, 2014

(30) Foreign Application Priority Data
Nov. 19, 2014 (CN) 201410665318.1

(51) Int. Cl. B05D 1/32; C09J 133/12; C09J 163/00; C09J 167/00; B05D 1/02; C09J 5/00

(52) U.S. Cl. CPC B05D 1/322; B05D 1/02; C09J 5/00; C09J 163/00; C09J 167/00; C09J 133/12
USPC 427/110; 427/207.1

(57) ABSTRACT

A method of processing a substrate or panel is disclosed. A substrate having thereon an array of chips is provided. A mask layer is laminated on the substrate. The mask layer has a plurality of openings to reveal active areas of the chips respectively. A spray-coating process is then performed to form an adhesive film in the active areas. The mask layer is then stripped off.

### BACKGROUND OF THE INVENTION

1. Field of the Invention

The present invention relates to a touch panel technology, and particularly relates to a panel lamination method.

2. Description of the Prior Art

In today's various types of consumer electronic products, such as tablet PCs, personal digital assistant (PDA) devices, mobile phone devices, satellite navigation systems, video players, and other portable electronic products, touch panel components have been widely used as the man-machine interface to communicate the information.

Typically, a touch panel element includes a sensor substrate and protective cover. The sensor substrate is laminated with the protective cover using an optical adhesive film. However, the optical adhesive film used in the conventional bonding or lamination method is too thick, usually to a thickness of 25 microns. This limits the further thinning of the touch devices.

Therefore, a need remains in the art for an improved method of laminating or processing a panel or a substrate in order to achieve further thinning of the touch panel devices.

### SUMMARY OF THE INVENTION

To solve the above problems and improve the quality of bonding, the present invention provides a method of processing a panel or substrate such that the thickness of a touch panel element can be further decreased.

According to one embodiment of the invention, a method of processing a substrate or panel is disclosed. A substrate having thereon an array of chips is provided. A mask layer is laminated on the substrate. The mask layer has a plurality of openings to reveal active areas of the chips respectively. A spray-coating process is then performed to form an adhesive film in the active areas. The mask layer is then stripped off.

According to the embodiments of the invention, the mask layer may comprise a releasable adhesive, a metal mask, or a combination thereof.

According to the embodiments of the invention, the spray-coating process may employ an adhesive material having a low viscosity that ranges between 10 centipoise (cps) and 3000 cps.

According to the embodiments of the invention, the adhesive material having a low viscosity may comprise epoxy resins, polyesters, or polymethyl methacrylate (PMMA).

According to the embodiments of the invention, the adhesive film may have a thickness that is smaller than 5 micrometers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-4 demonstrate a method of processing a panel or a substrate according to one embodiment of the invention.

FIGS. 5-7 depict various embodiments wherein the mask layer has different types or combinations to form different structural features in the adhesive film.

### DETAILED DESCRIPTION

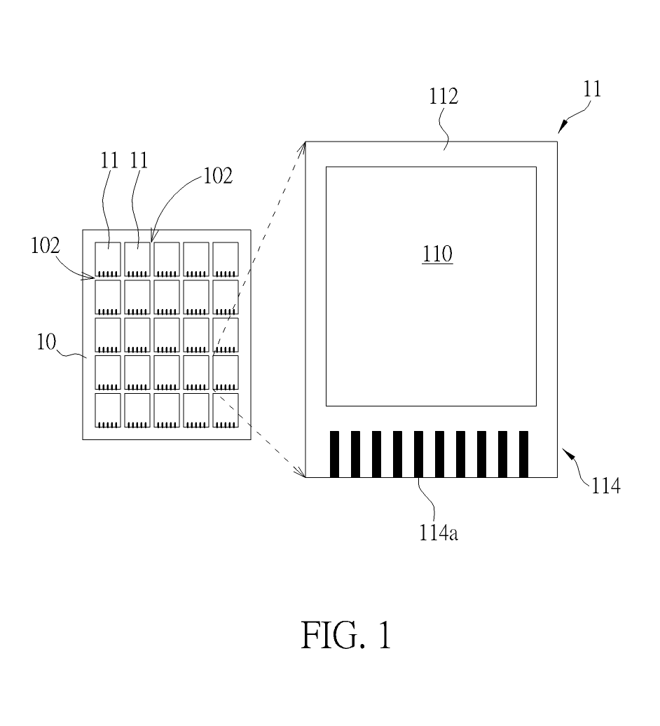

FIGS. 1-4 demonstrate a method of processing a panel or a substrate according to one embodiment of the invention.

First, as shown in FIG. 1, a substrate 10, such as a sensor substrate of a touch panel device, is provided. A plurality of chips 11 in an array (in this example to 5×5 array arrangement) is provided on the substrate 10. The chips 11 are separated from one another by a cutting lane 102.

According to the embodiment of the invention, the aforesaid substrate 10 may comprise a transparent substrate and at least one sensor electrode layer (not shown), but not limited thereto.

The aforesaid transparent substrate may comprise a polyethylene terephthalate (PET) substrate or a glass substrate, but not limited thereto.

The aforesaid sensor electrode layer may comprise indium tin oxide (ITO) transparent electrode, but not limited thereto.

As can be seen in the enlarged area in FIG. 1, each of the chips 11 may comprise an active area 110, a peripheral area 112 that surrounds the active area 110, and a FPC (flexible printed circuit) bonding area 114. The aforesaid active area may also be referred to as display area or effective area.

According to the embodiment of the invention, a plurality of gold fingers 114a may be disposed within the FPC bonding area 114.

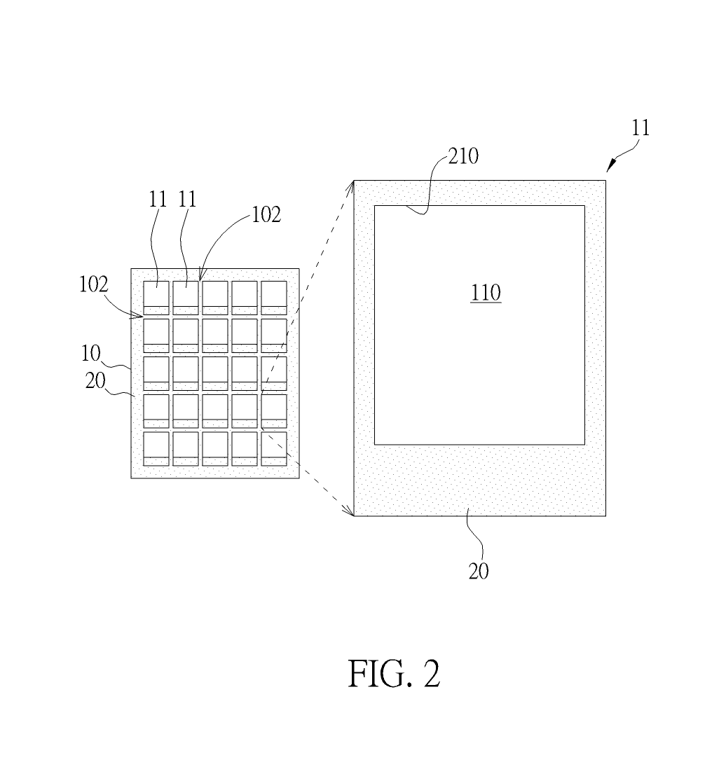

As shown in FIG. 2, a mask layer 20 is laminated onto the substrate 10. The mask layer 20 may comprise a plurality of openings 210 to respectively expose the active areas 110 of the chips 11.

The surfaces of the substrate 10 except for the active areas 110 are masked. More specifically, the cutting lanes 102, the peripheral areas 112, and the FPC bonding areas 114 are masked by the mask layer 20.

According to the embodiment of the invention, the aforesaid mask layer 20 may comprise a releasable adhesive, a metal mask, or a combination thereof.

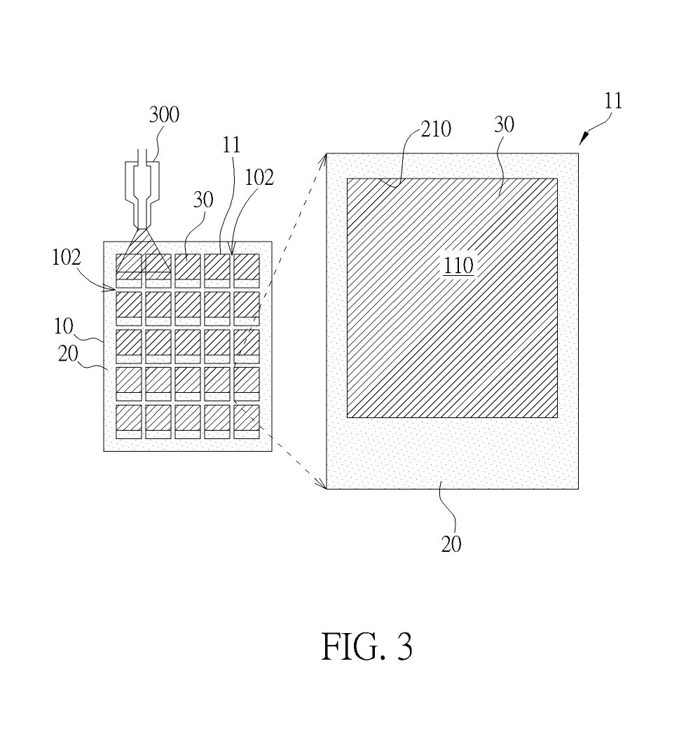

As shown in FIG. 3, a spray-coating process is carried out to form an adhesive film 30 onto the exposed active areas 110 that are not masked by the mask layer 20 by using a spray coating apparatus 300.

According to the embodiment of the invention, to form the adhesive film 30, the aforesaid spray-coating process employs an adhesive material having a low viscosity that ranges between 10 centipoise (cps) and 3000 cps.

According to the embodiment of the invention, the aforesaid adhesive material having a low viscosity may comprise epoxy resins, polyesters, or polymethyl methacrylate (PMMA).

According to the embodiment of the invention, the aforesaid adhesive film 30 has a solvent residue rate that is greater than 1%.

According to the embodiment of the invention, the aforesaid adhesive film 30 has a thickness that is smaller than 5 micrometers.

According to the embodiment of the invention, the aforesaid adhesive film 30 has a uniformity that is smaller than 10%.

According to the embodiment of the invention, the aforesaid adhesive film 30 has a surface roughness Ra that is greater than 0.01 micrometers, wherein Ra is center line average roughness.

According to the embodiment of the invention, the aforesaid adhesive film 30 has a surface profile variation of about 0.3 μm/mm.

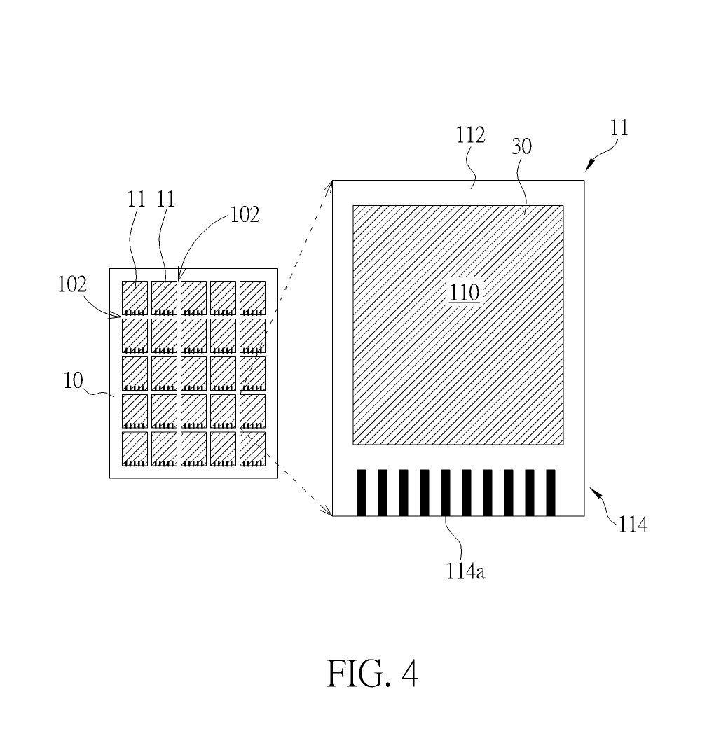

As shown in FIG. 4, subsequently, the aforesaid mask layer 20 is removed, leaving the array pattern of the adhesive film 30 intact. At this point, it is understood that the adhesive film 30 is only formed within the active areas 110 of the chips 11. The adhesive film 30 has a thickness of less than 5 micrometers.

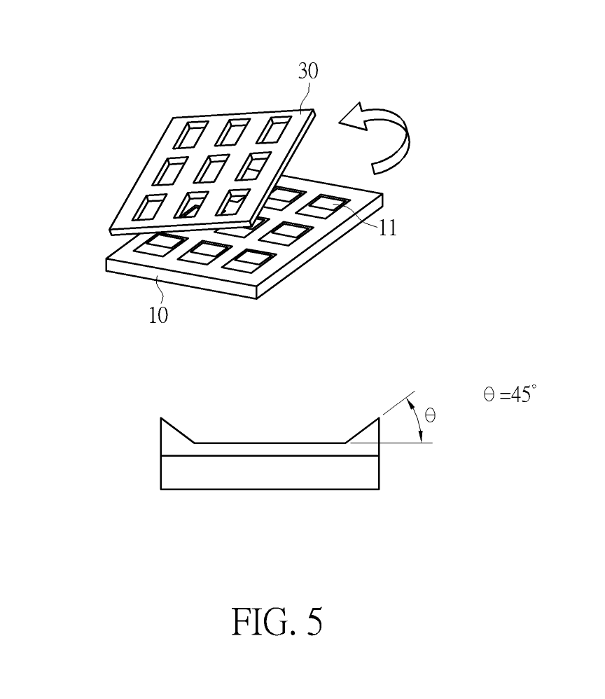

According to the embodiments of the invention, the mask layer 20 may have different types or combinations to form different structural features in the adhesive film 30, as shown in FIGS. 5-7.

FIG. 5 depicts an embodiment wherein the mask layer 20 is a releasable adhesive. After stripping the releasable adhesive, along the perimeter of each of the active areas 110, a slope structure or a protrusion may be formed in the adhesive film 30, wherein a twist angle θ may be greater than 15 degrees.

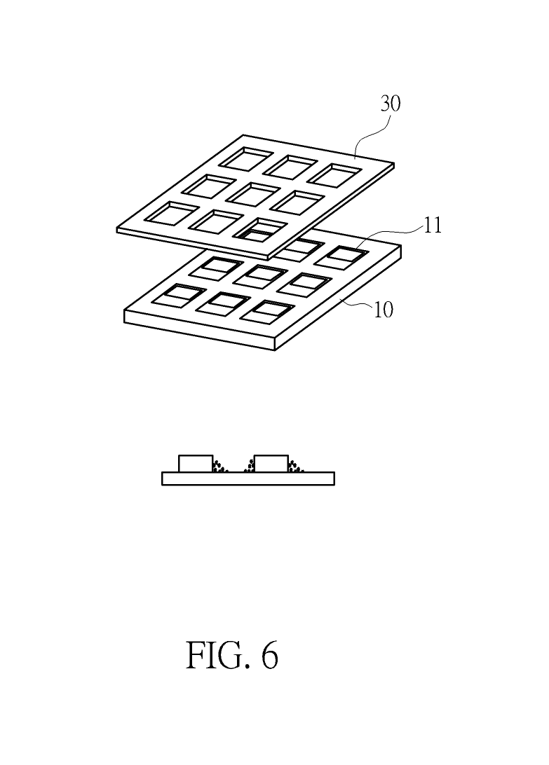

FIG. 6 depicts an embodiment wherein the mask layer 20 is a metal. Because the masked areas may not be tightly masked, splashing may occur during the spray-coating process. Colloidal particles may be deposited according to a Gaussian distribution from the active area 110 to the surrounding masked area.

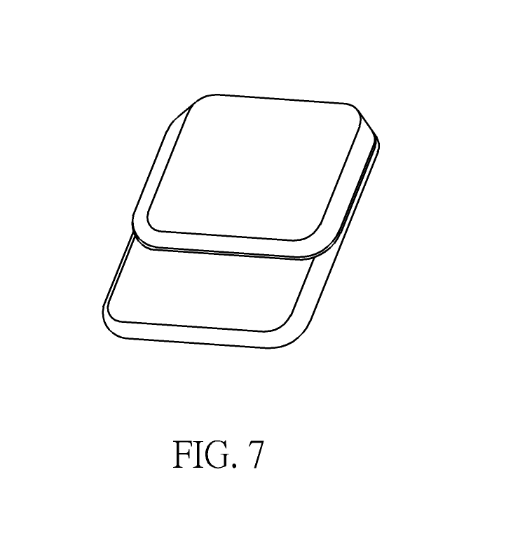

FIG. 7 depicts an embodiment wherein the mask layer 20 is a combination of metal and releasable adhesive. An R angle may be seen along the perimeter of the adhesive film 30 within each of the active areas 110. The aforesaid R angle may be greater than 0.1 mm.

After completing the steps of forming the patterned adhesive film 30 as set forth through FIGS. 1-4, the substrate 10 may then be laminated with another substrate.

The aforesaid another substrate may be a glass substrate including, but not limited to, a soda lime substrate, a cover glass, or a sapphire substrate.

Alternatively, the aforesaid another substrate may be a sheet substrate such as a PET film, an ITO film, or piezoelectric materials.

After the above-mentioned substrates are laminated and bonded together, a post treatment process such as UV curing, post-baking, or chemical strengthening treatments may be performed. Thereafter, a cutting process may be performed to singulate the plurality of chips 11.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of processing a substrate, comprising:
providing a substrate having thereon a plurality of chips;
laminating a mask layer on the substrate, wherein the mask layer has a plurality of openings to reveal active areas of the chips respectively;
performing a spray-coating process to form an adhesive film in the active areas; and
stripping the mask layer off.

2. The method of processing a substrate according to claim 1, wherein the spray-coating process employs an adhesive material having a low viscosity that ranges between 10 centipoise (cps) and 3000 cps.

3. The method of processing a substrate according to claim 2, wherein the adhesive material having a low viscosity comprises epoxy resins, polyesters, or polymethyl methacrylate (PMMA).

4. The method of processing a substrate according to claim 1, wherein the adhesive film has a solvent residue rate that is greater than 1%.

5. The method of processing a substrate according to claim 1, wherein the adhesive film has a thickness that is smaller than 5 micrometers.

6. The method of processing a substrate according to claim 1, wherein the adhesive film has a uniformity that is smaller than 10%.

7. The method of processing a substrate according to claim 1, wherein the adhesive film has a surface roughness Ra that is greater than 0.01 micrometers.

8. The method of processing a substrate according to claim 1, wherein the adhesive film has a surface profile variation of about 0.3 μm/mm.

9. The method of processing a substrate according to claim 1, wherein the mask layer is a releasable adhesive.

10. The method of processing a substrate according to claim 1, wherein the mask layer is a metal mask.

11. The method of processing a substrate according to claim 1, wherein the substrate comprises a transparent substrate and at least one sensor electrode layer.

12. The method of processing a substrate according to claim 1, wherein the plurality of chips are arranged in an array and are separated from one another by a cutting lane.
